(19) United States
(12) Patent Application Publication
(10) Pub. No.: US 2016/0031142 A1
(43) Pub. Date: Feb. 4, 2016

(54) ROTARY TOOL EJECTION TECHNOLOGY

(71) Applicant: Weidenmiller Company, Itasca, IL (US)

(72) Inventors: Stephen J Kras, Chicago, IL (US); Rich Paul Budek, Elmhurst, IL (US)

(21) Appl. No.: 14/810,612

(22) Filed: Jul. 28, 2015

Related U.S. Application Data
(60) Provisional application No. 62/030,576, filed on Jul. 29, 2014.
(60) Provisional application No. 62/030,587, filed on Jul. 29, 2014.

(51) Int. Cl. B29C 47/00; A23P 1/12

(52) U.S. Cl. CPC B29C 47/0066; A23P 1/12

(57) ABSTRACT

A rotary tool ejection technology utilizing manifolded air to eject contents from the cavities of a rotary cylinder. The cavities include orifices. The orifices are aligned with a channel positioned within the rotary cylinder such that fluid (including air and gas) in the channel exits the orifices. The orifices are assembled with porous inserts. Air entering the channel is ejected from the orifices, creating force acting on the contents of the cavity thereby causing ejection.

### RELATED APPLICATIONS

The present patent document claims the benefit of the filing date under 35 U.S.C. §119(e) of Provisional U.S. Patent Application Ser. No. 62030576, filed Jul. 29, 2014, and Provisional U.S. Patent Application Serial No. 62030587, filed Jul. 29, 2014, each of which is hereby incorporated by reference in its entirety, including all drawings and documents filed therewith.

### BACKGROUND

Consumers increasingly rely upon the convenience of packaged food products. Convenience foods for both animals and humans have proliferated—and range from healthy to indulgent. Consumables such as but not limited to cookies, candies, crackers, and animal nourishment, come in a variety of textures, compositions, shapes, and sizes. Rotary die cutters and rotary die molds are a popular method of forming consumable food products.

### BRIEF SUMMARY

A rotary die ejection technology is disclosed. A rotary cylinder includes die cavities and/or die cutters arranged on its surface and assembled with ejection orifices. The ejection orifices are in fluid communication with the air channels disposed beneath. The ejection orifice is associated with a porous material. The porous material may exist as a porous insert or as a porous cylinder. A porous insert is fit and retained into the die cavity and/or die cutter.

The rotary cylinder may be further divided into a surface cylinder and a manifold cylinder. The manifold cylinder may be nested within the surface cylinder. A porous cylinder may be assembled between the rotary cylinder and the manifold.

Other features and advantages of the disclosure will be, or will become, apparent to one of skill in the art upon examination of the following figures and detailed description. It is intended that all such additional advantages and features be included in the description, be within the scope of the invention, and be protected by the claims.

### BRIEF DESCRIPTION OF THE DRAWINGS

FIG. 1 provides a view of a first rotary tool;

FIG. 2 provides a view of an end of a first rotary tool;

FIG. 3 provides an assembly view of a first rotary tool;

FIG. 4 provides a view of a rotary tool with cutter cavity;

FIG. 5 provides a second cross section of a rotary tool with cutter cavity;

FIG. 6 provides a third cross section of a rotary tool with cutter cavity;

FIG. 7 provides a cross section of a rotary tool with cutter cavity;

FIG. 8 provides cross section of a rotary tool with mold cavity;

FIG. 9 provides a close up view of an exemplary surface cylinder including mold cavity with design;

FIG. 9A provides a side cross section of the mold cavity of the surface cylinder;

FIG. 10 provides a close up perspective view of mold cavity with porous insert;

FIG. 11 provides an exemplary view of a rotary cutter;

FIG. 12 provides an enlarged view of an angled docker pin plug;

FIG. 13 provides an enlarged view of a barb docker pin plug;

FIG. 14 provides an assembly view of a variation of the rotary tool of FIG. 3 with the addition of a porous cylinder; and

FIG. 15 provides a cross section of the rotary tool of FIG. 14.

### DETAILED DESCRIPTION OF THE DRAWINGS

Food products of various kinds, including cookies, crackers, candies, animal consumables, and other products, are frequently formed by high-volume automated rotary mold and/or rotary cutting devices. A rotary die is a cylinder, the surface of which is covered with shallow engraved cavities. A rotary cutter is a cylinder, the surface of which is covered with portions that rise about the face of the cylinder. Hybrid forms may also exist which include both engraved cavities and raised portions. In one exemplary process, the cylinder rotates past the opening in a hopper filled with food product (e.g., a food dough). The food product fills any engraved portions on the cylinder. Excess dough is sheared off from the main mass by a blade. As the cylinder continues to rotate, the dough pieces are ejected, e.g., onto a conveyor belt. In some variations, there are two counter rotating rolls, e.g., a molding roll and a feed roll. The dough may fill the pinch point created by the two rolls and may be thereby forced into a mold cavity.

In another exemplary process, rotary die cutting uses a cylindrical die on a rotary press. A long sheet or web of material is fed through the rotary press into an area which holds a rotary tool, for example but not limited to, a rotary die cutter or a rotary die mold. The rotary tool may cut out shapes, make perforations or creases, impart aesthetic design, and/or cut the sheet or web into smaller parts. In a variation, rotary die cutting allows for the manufacture of multiple substantially identical formed products. In a variation, a molder may have several different shapes per roll, for example, cookies in the shape of various animals.

Several processes are used to release the formed product from the rotary tool. Some use fat and lard as lubricants to discourage attachment of the food product to the rotary tool. For example, some manufacturers increase the fats and/or oils used in dough recipes to achieve a dough that will have reduced affinity for the rotary tool. However, the addition of fat to foods has become less desirable to consumers who are weight and/or health conscious. With the rising popularity of fat-free products, the industry increasingly adopted rotary tool coatings to assist release of formed shapes. Examples of rotary tool coatings include formulations of TEFLON and ceramics that are FDA and USDA approved for food contact.

Many known coatings wear out from repeated use; therefore the rotary tools require routine maintenance. As the rotary tool coatings wear out, the release fidelity decreases. Product increasingly sticks to the surface of the rotary tool. Decreases in fidelity result in considerable expense due to lost food product (e.g., through deformations, and sticking), down time, and loss of efficiency. Furthermore, the maintenance process results in downtime. Maintenance requires removing the subject machine from operation while the rotary tool is removed for reconditioning. The reconditioning process takes several days to several weeks and bears a significant expense. In an attempt to realize a large product output despite the maintenance inefficiencies, many companies are required to run several machine lines so that they can rotate production and maintenance. This requires larger more expensive facilities to house redundant machinery.

We disclose a rotary tool ejection technology that is capable of operating at high efficiency with minimal maintenance. In one variation, the rotary tool ejection technology eliminates the requirement of rotary tool coatings. In a variation, the rotary tool ejection technology eliminates the requirement of the use of lubricants, including by increasing the fat content of the food product. In a variation, the rotary tool ejection technology features a rotary tool with no internal moving parts, further reducing maintenance concerns. The reduction of moving parts further increases the sanitation of the system, as moving parts often create additional surfaces in which food product may be trapped.

We also disclose a novel method of employing a porous material within the rotary tool system. In one variation, the porous material may be a porous metal material that has inter-connected porosity. A porous metal material may be fabricated from metal powder particles using powder metallurgy techniques. The porous material may have a range of pore sizes from about 0.5 micrometer to about 200 micrometers.

### DEFINITIONS

Definitions: unless stated to the contrary, for the purpose of the present disclosure the following terms shall have the following definitions:

A reference to “another variation” in describing an example does not imply that the referenced variation is mutually exclusive with another variation unless expressly specified.

The terms “a,” “an” and “the” mean “one or more,” unless expressly specified otherwise.

The phrase “at least one of” when modifying a plurality of things (such as an enumerate list of things) means any combination of one or more of those things, unless expressly specified otherwise.

The term “represent” and like terms are not exclusive, unless expressly specified otherwise. For example, the term “represents” does not mean “represents only,” unless expressly specified.

The term “e.g.” and like terms means “for example, but not limited to” and thus does not limit the term or phrase it explains.

The term “porous material” refers to a material that has inter-connected porosity and/or a material that is microdrilled. A porous material may be fabricated from metal powder particles using powder metallurgy techniques. The porous material may comprise synthetic materials, ceramics, or combinations and composites thereof. The porous material may be a sintered material or may be a micro-drilled material. The porous material may have a range of pore sizes (whether created by a sintering process or by micro-drilling) from about 0.1 micrometer to about 300 micrometers. For example, the porous material may have a pore size in the range in micrometers of about 0.1 -300, 0.2-100, 5.0-50, 20-50, or any individual value or range falling in between the listed ranges. Additionally or alternatively, the pore size within a porous material may vary throughout the material or the porous material may include pores of more than one pore size within the disclosed ranges.

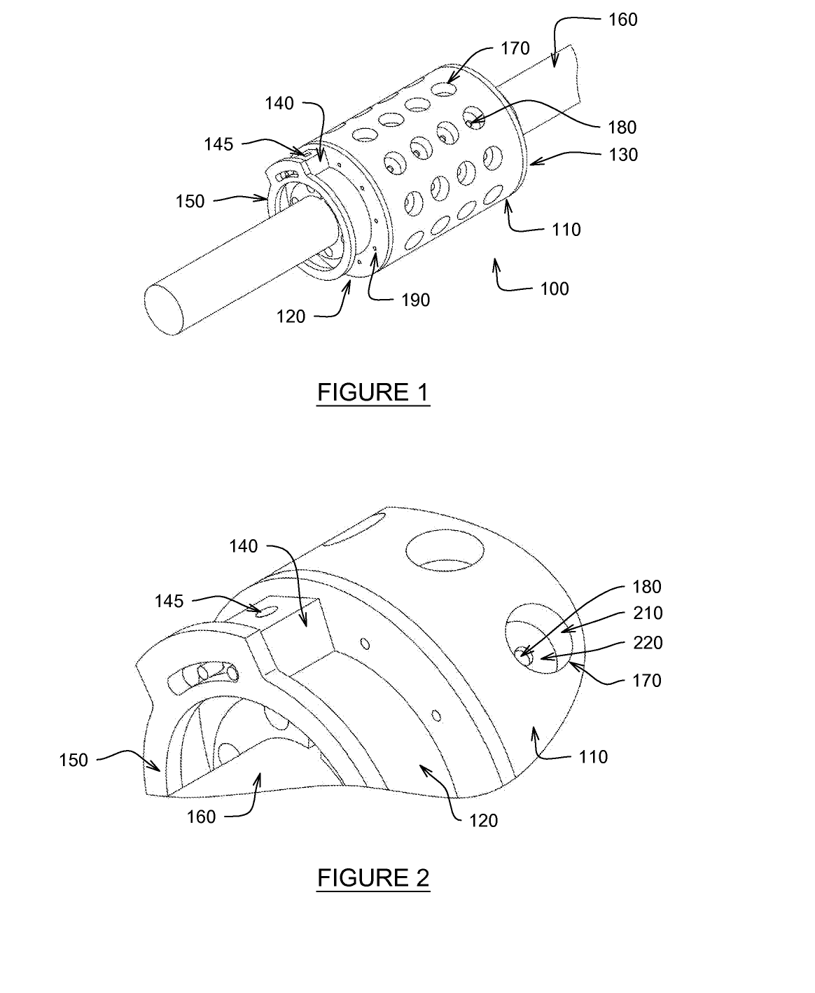

FIG. 1. A first rotary tool 100 may include a rotary cylinder 110. The first rotary tool 100 may also include a first hub 120 and a second hub 130. The rotary tool 100 may also include an air block 140 and an adjustment plate 150. The air block 140 may be capable of receiving fluid, including gas, through air block opening 145. A shaft 160 may pass through the first rotary tool 100. For example, a shaft 160 may enter the rotary tool 100 by passing through the first hub 120 and exiting through the second hub 130.

In a rotary mold variation, the rotary cylinder 110 may be a continuous surface having a plurality of cavities 170, e.g., mold cavities, defined therein. For illustration, the cavities 170 are shown as circular recesses. It should be understood that the cavities 170 may take a multitude of shapes, including but not limited to, ovals, squares, triangles, as well as novelty shapes, such as but not limited to, animals (e.g., horses, birds, dogs, fish), objects of nature (e.g., trees, flowers, clouds, planets), random objects (e.g., telephone, car, house, windmill, airplane, hand tools) and etc. The rotary cylinder 110 may include an orifice 180 passing there through.

The rotary cylinder 110 may be abutted on a first end by the first hub 120 and on the second end by the second hub 130. The first hub 120 may include a series of ports 190. The ports 190 may be spaced around the circumference of the first hub 120 (e.g., the hub may have radially spaced ports).

An air block 140 may be assembled with the first hub 120. For example, the air block 140 may be in a sealed contact arrangement to the abutting surface of the first hub 120. Additionally or alternatively, the air block 140 may be assembled with an adjustment plate 150. The adjustment plate 150 may permit adjustment of the timing, location, and/or force of the air passing through the air block 140. (See also, FIG. 2.)

FIG. 2 provides a partial view of a portion of the first rotary tool 100. This view provides a clearer view of the cavity 170. The cavity 170 may have side walls 210 and a bottom wall 220. The bottom wall 220 may include an orifice 180 passing there through. While only one orifice 180 is shown, the bottom wall 220 may include multiple orifices 180.

The bottom wall 220 may be continuous with the side wall 210. For example, in one variation, the cavity 170 may be engraved into the outer surface of a single-piece cylinder such that the side walls 210 are continuous with the bottom wall 220. The cavity 170 of the first rotary tool 100, having a continuous relationship between the side walls 210 and bottom wall 220, achieve surface integrity e.g., with fewer nooks capable of trapping food material.

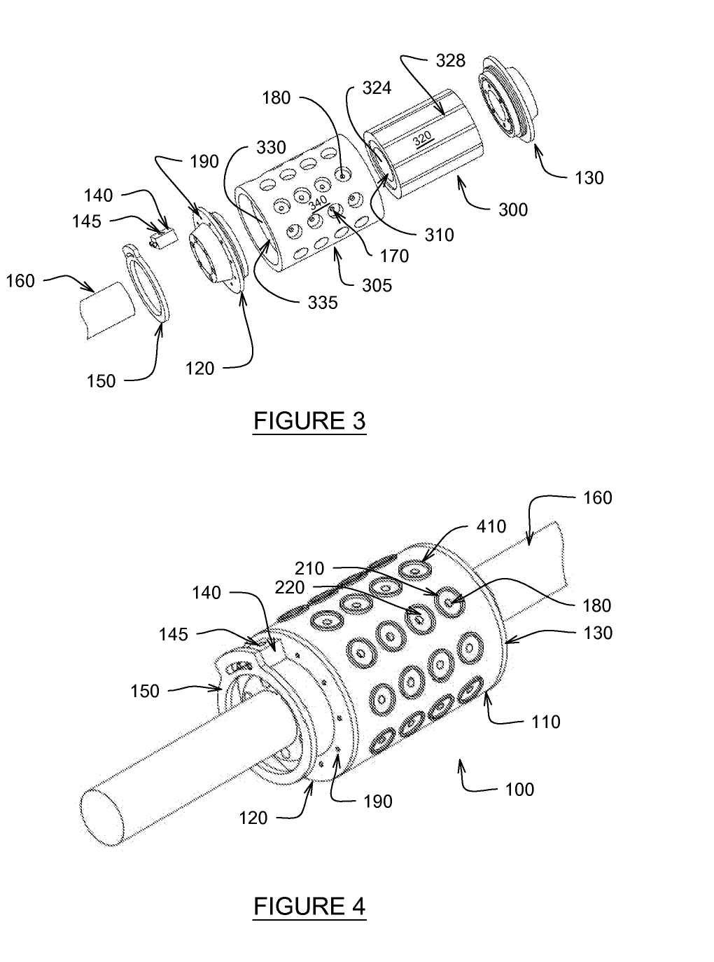

FIG. 3 provides an assembly view of a variation of a rotary tool. In a variation, a rotary cylinder 110 may include a surface cylinder 305, a first hub 120, a second hub 130, a manifold cylinder 300, a shaft 160, an adjustment plate 150, and an air block 140. The manifold cylinder 300 may be a hollow cylinder, defining a manifold opening 310. The manifold cylinder 300 may have an outer manifold surface 320 and an inner manifold surface 324. The outer manifold surface 320 may include channels 328. The channels 328 may be arranged longitudinally on the outer manifold surface 320. The channels 328 may be applied to the surface of the manifold cylinder 300 in any effective manner. The number and spacing of the channels 328 may vary depending on the desired application.

The surface cylinder 305 may be a hollow cylinder, defining an assembly opening 335 there through. The surface cylinder 305 may have an inner face 330 and a surface face 340. In a rotary mold variation, the surface cylinder 305 may have a plurality of cavities 170 defined therein. The cavities 170 may be arranged in longitudinal rows of one or more cavities 170 on the surface cylinder 305. The cavities 170 may include an orifice 180 passing there through. For example, the orifice 180 (when unobstructed) may allow the passage of light shown on the surface face 340 of the surface cylinder 305 to shine completely through to the inner face 330 of the surface cylinder 305 and/or any manifold cylinder 300 assembled therein.

The surface cylinder 305 may be assembled with the manifold cylinder 300, for example, by inserting the manifold cylinder 300 into the assembly opening 335 of the surface cylinder 305. The surface cylinder 305 and manifold cylinder 300 may be dimensioned such that, when the manifold cylinder 300 is inserted into the surface cylinder 305, there is a close fit. The channels 328 on the outer manifold surface 320 may align with the orifice 180 located in the cavities 170. Alignment of the channels 328 on the outer manifold surface 320 with the orifice 180 located in the cavities 170 may permit fluid communication between the channels 328 and the orifice 180.

The manifold cylinder 300 may be assembled inside the surface cylinder 305, and the assembly may be abutted by a first hub 120 and a second hub 130. The first hub 120 may include ports 190, which may be spaced around the circumference of the first hub 120. The ports 190 in the first hub 120 may align with the channels 328 in the manifold cylinder 300. In a variation, air may be delivered to the channels 328 through the ports 190 in the first hub 120.

FIG. 4 provides an illustration of a rotary cutter variation. In a rotary cutter variation, the rotary cylinder 110 may have an outer surface. The rotary cylinder 110 may have one or a plurality of cutter cavities 410 defined thereon. For illustration, the cutter cavities 410 are shown in circular format. It should be understood that the cutter cavities 410 may take a multitude of shapes, including but not limited to, ovals, squares, triangles, as well as novelty shapes, such as but not limited to, animals (e.g., horses, birds, dogs, fish), objects of nature (e.g., trees, flowers, clouds, planets), random objects (e.g., telephone, car, house, windmill, airplane, hand tools) and etc. The rotary cylinder 110 may include an orifice 180 passing there through.

FIG. 4 serves to illustrate that the rotary cylinder 110 may be provided with a mold cavity 170 and/or with a cutter cavity 410. The rotary tool variation of FIG. 4 otherwise incorporates all elements of the rotary tool 100 variation of FIGS. 1-2. For example, the cutter cavity 410 may have side walls 210 and a bottom wall 220. The bottom wall 220 may include an orifice 180 passing there through. While only one orifice 180 is shown, it should be understood that the bottom wall 220 may include multiple orifices 180. The bottom wall 220 may be continuous with the side wall 210. The bottom wall 220 of the cutter cavity 410 may be continuous with and in the same plane as the surface of the rotary cylinder 110. Alternatively or additionally, the bottom wall 220 of the cutter cavity 410 may be above or below the plane of the surface of the rotary cylinder 110 (e.g., the cavity may be machined below the plane and the cutter walls may emerge above the plane.)

Further, the rotary cylinder 110 may be abutted on a first end by the first hub 120 and on the second end by the second hub 130. The first hub 120 may include a series of ports 190. The ports 190 may be spaced around the circumference of the first hub 120.

An air block 140 may be assembled with the first hub 120. For example, the air block 140 may be in a sealed contact arrangement to the abutting surface of the first hub 120. Additionally or alternatively, the air block 140 may be assembled with an adjustment plate 150. The adjustment plate 150 may permit adjustment of the timing, location, and/or force of the air passing through the air block 140. (See also, FIG. 2.)

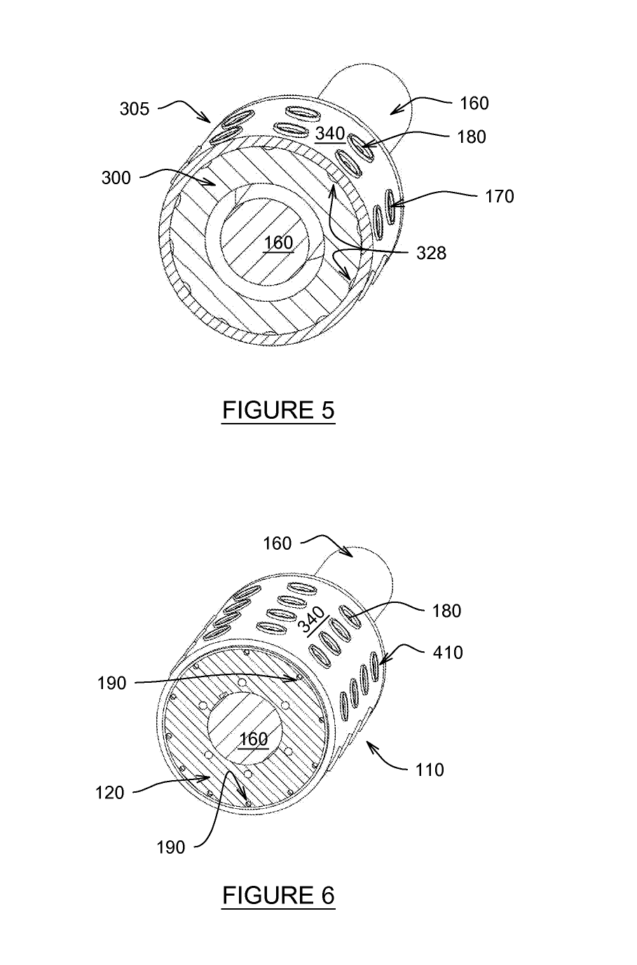

Turning now to FIG. 5, a cross section view of the surface cylinder 305 assembled with the manifold cylinder 300. (The surface cylinder 305 is shown as a cutter cavity variation, however, it should be understood that the surface cylinder 305 with a mold cavity variation may be substituted herein.) When the manifold cylinder 300 is inserted in the assembly opening 335 of the surface cylinder 305, the inner face 330 of the surface cylinder 305 covers the channels 328. The channels 328 run beneath and are in fluid communication with the orifice 180 of the cavities 170. In one variation, air travels through the channels 328 to the orifices 180. Air flowing from the orifice 180 may create a force acting on material, (e.g., food material), present in the cavity 170.

In another variation, the channels 328 may be directly drilled into any one of the rotary cylinder 110, the surface cylinder 305 and/or the manifold cylinder 300. The channel 328 may be located in any location permitting the channel to deliver air to the cavities 170. For example, the channel 328 may be disposed beneath and in fluid communication with the cavities 170.

Rotary dies, in general, may be made of a variety of materials. In some applications, the rotary die surface material may be, e.g., brass, brass alloy, tool and stainless steel metal. We disclose a rotary tool, which, by elegant design, permits the use of a brass or other suitable materials in an affordable manner. For example, in one variation, the manifold cylinder 300 may be made of a material such as but not limited to stainless steel. In another variation, stainless steel may be used for the surface cylinder 305. In another variation, the surface cylinder 305 may be made of a porous material. If the surface cylinder 305 is made of a porous material, an optional hard surface coating may be applied to the surface cylinder 305. In a variation, the surface coating would not penetrate deeply into the porous structure from the exterior surface of the surface cylinder 305.

While there are other ways to accomplish channeling air to the orifices 180, the present method is novel and has several advantages. The following discussion is included to explore the advantages without limiting the scope of the disclosure.

The disclosed structural arrangement may have the advantage of permitting implementation of the ejection technology into existing rotary dies. For example, conversion may require merely removing the existing surface cylinder 305, adding orifices 180 by drilling, and adding complementary channels 328 to the material existing beneath the surface cylinder 305 (either surface channels as shown in FIG. 3, direct drilled channels as discussed herein, or any known manner of introducing channels). Additional assembly items for introducing and/or regulating airflow could then be added. In one variation, the disclosed technology may be adapted to any manufacturing assembly as the technology is devised for easy conversion. Other variations are also contemplated which would include integrating air ejection into the overall machine design.

Turning to FIG. 6, a section view cut through the first hub 120 shows ports 190 in alignment with cavities 170, and orifices 180. In this view, the first hub 120 covers the rotary cylinder 110, however, it can be understood by alignment and comparison of FIG. 4 and FIG. 5, that the ports 190 of the first hub 120 align with and are in fluid communication with the channels 328 of the rotary cylinder 110. In a variation, air entering the ports 190 flows into the channels (FIG. 4, 328) and the channels supply air to orifices 180.

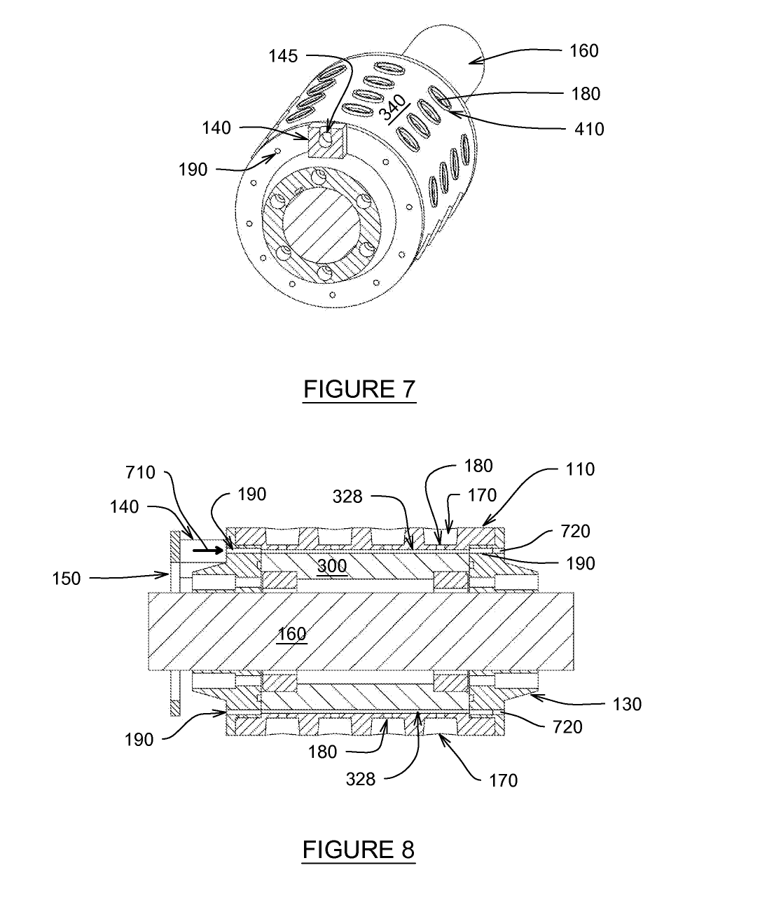

Turning to FIG. 7, a cross section is cut through air block 140 showing the air block opening 145, revealing a path or channel for air flow to the ports 190 in the first hub 120. As in FIG. 4 and FIG. 5, the ports 190 are in alignment with the orifice 180 located in the cavity 170. In this view, the first hub 120 blocks a view of the rotary cylinder 110. However, comparing FIG. 5 and FIG. 7, it is seen that the ports 190 are also in alignment with the channel FIG. 5, 328 in the manifold cylinder 300. Air enters the air block 140 through the air block opening 145 and is delivered through the ports 190 to the channels FIG. 5, 328, the channels FIG. 5, 328 supply air to orifices 180. The air supplied to the orifices 180 may provide an ejection force acting on any materials in the cavities 410 (or FIG. 1, 170).

In each of FIGS. 5-7, the shaft 160 is assembled through the manifold cylinder 300. In a variation, the rotary tool 100 includes the manifold cylinder 300 assembled with the surface cylinder 305, and further assembled with the first hub 120 and the second hub 130, which are supported by the shaft 160. The rotary tool 100 rotates while the air block 140 is stationary. Air is supplied to the air block 140. As the rotary tool 100 rotates relative to the air block 140, the ports 190 on the first hub 120 rotate into alignment with the air block opening 145. When a port 190 is in alignment with the air block opening 145, air is supplied to the port 190. The air supplied by the port 190 passes through the channels 328 and exits through the orifices 180. As the rotary tool 100 rotates relative to the air block 140, the ports 190 rotate out of alignment with the air block 140. When the ports 190 rotate out of alignment with the air block 140, air flow to the channels 328 ceases.

FIG. 8 provides a cross section view of a rotary tool assembled with an air block 140 (in cross section) and an adjustment plate 150 (in cross section). This view provides further illustration of air flow. The section is cut through a centerline of a port 190 in the first hub 120 in alignment with a channel 328 and also in cross section alignment with orifices 180 through the cavities 170. Direction of air flow is indicated by the arrow 710. Air enters the air block 140 and, when the air block 140 is aligned with a port 190, air travels through the port 190 into the channel 328 and is ejected through the orifices 180. The air supplied to the orifices 180 provide an ejection force to any materials in the cavities 170 (or FIG. 4, 410).

While we refer in the examples to assembly of the air block 140 with the first hub 120, the air block assembly may also be assembled with the second hub 130. The second hub 130 may also include ports 190 arranged for alignment with the channels 328 (e.g., channels 328 of the manifold cylinder 300, the rotary cylinder 110, or the surface cylinder 305). In FIG. 8, we see that the ports 190 in the second hub 130 are plugged by a stop 720 to end the air channel.

FIG. 1 through FIG. 3 illustrate a rotary tool with cavities 170, which are visually displayed as mold form cavities. A generic geometry is shown. The round cavity is meant only for demonstration and the cavity may be of any shape as determined by the shape of the desired food product. In FIG. 4 through FIG. 7, we replace the mold form cavity with a cutter form cavity to demonstrate that either structural variation is within the scope of this disclosure. Again, the generic round shape is a placeholder for any shape desired. In an alternative or additional variation, the mold cavity 170 may serve to retain press-fit molds of multiple designs. Additionally or alternatively, the cavities 170 may serve to retain molds of multiple designs retained by methods of retention, including but not limited to, screw fit, adhesive, weld, and braze. In this example, the surface of the rotary cylinder 110 may include cavities 170 capable of receiving therein a retained mold of various designs. This may permit the rotary tool 100 to be repurposed for many different products.

The rotary tool 100 may be supported at each end by a first hub 120 and a second hub 130, which may be flanged hubs. The first hub 120 and/or the second hub 130 may be assembled with a portion of the air supply, e.g., the air block 140. In operation, the rotary tool 100 may receive material, such as dough, into mold cavity 170 and cutter cavity 410 while the rotary tool 100 rotates continuously on the shaft 160. Air may be supplied through the air block 140 into the ports 190 and thereby provide a pulse of air into the channels 328 where the air is delivered to the orifice 180. The pulse of air entering the channel 328 may create an internal pressure if the row of cavities 170 contain content that is obstructing the orifice 180. The pressure differential between the channel 328 and the exterior (e.g., atmosphere) of the rotary cylinder 110 may create a force that acts on the molded food stuff and may release or eject the food stuff from the mold cavity 170 and/or cutter cavity 410. The air may provide a force on the molded product to eject it from the cavities 170 at a position and phase (e.g., the phase of a product conveyor), suitable for collection and transport of the product for further processing. An adjustment of the timing or rotational position of the air block 140 (and thus the air delivered therefrom) may be accomplished via the adjustment plate 150. The duration of the air pulse may be adjustable by, among other things, adjustment of the size of the channel 328. The pressure and volume of air used can provide adjustment and optimization of air delivered to eject product.

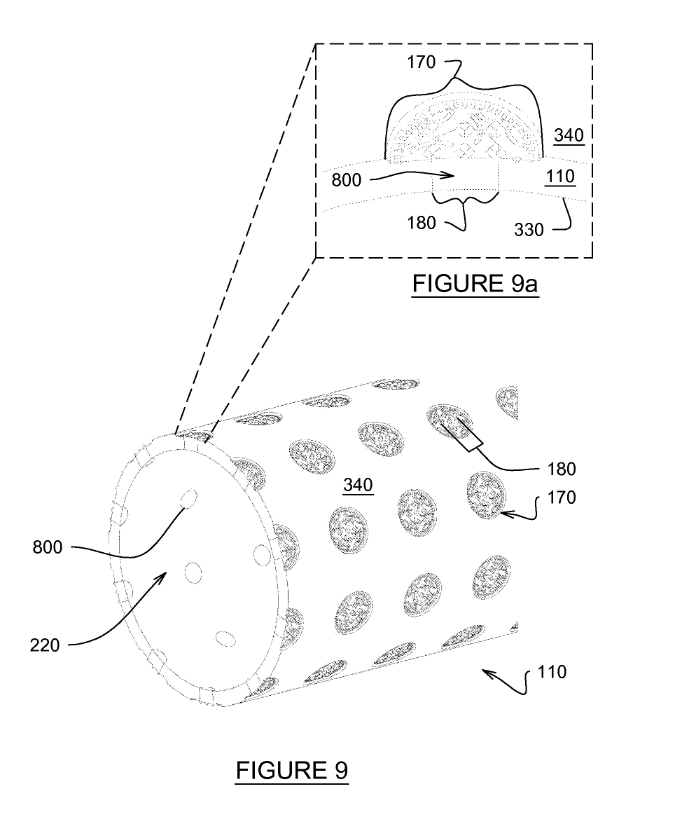

FIG. 1 through FIG. 8 illustrate mold cavity 170 and cutter cavity 410. The mold cavity 170 and cutter cavity 410 is used as a generic representation of die roll cavities. A rotary die may generally have a rotary mold format or a rotary cutter format. While generic cavities are demonstrated in FIG. 1 through FIG. 8 (and elsewhere herein), it should be understood that the mold cavity 170 and/or cutter cavity 410 may have raised and lowered portions which, when pressed against a dough material, impart a design. FIG. 9 provides an example of a rotary cylinder 110 with a design machined, etched, engraved, milled, molded or otherwise applied thereon.

FIG. 9 provides a variation of a surface cylinder 305, including designs and above inserts, which may be a plug 800. The plug 800 may be inserted such that a top portion of the plug 800 is above or below the plane of the bottom wall 220. In one example, the plug 800 may be inserted into the orifice 180 such that the plug 800 is continuous with the bottom wall 220 of the mold cavity 170 (or cutter cavity 410). The plug 800 may be inserted such that it forms an uninterrupted continuation of the bottom wall 220, including any design elements necessary to create an uninterrupted bottom wall 220. Design pattern continuity may provide a precise, finished, uninterrupted appearance to any resulting consumable, whether it is a cookie, cracker, animal treat, candy or otherwise.

The plug 800 may be a porous material. The porous material may have the advantage of preventing the content, e.g., a dough product from being caught or trapped in the orifice 180 of the cavity 170. In one example, a pore size of about 5 micrometers to about 50 micrometers may permit air to flow from the channel FIG. 3, 328 through the plug 800 assembled into the orifice 180, providing an ejection force on any dough material present in the cavity 170 (which may be a mold cavity and/or cutter cavity 410). A pore size of about 5 micrometers to about 50 micrometers may have the additional or alternative property of prohibiting the flow of content (e.g., dough, cookie dough, cracker dough, candy paste, and other food material) back into the plug 800 and/or orifice 180. The plug 800 may additionally or alternatively vent the cavity 170 (or any cavity disclosed herein), which may improve product fidelity by relieving entrapped air from the cavity. Entrapped air may prevent good packing. Good packing of dough into the cavity improves product quality and shape.

In the variation of FIG. 9, the plug 800 forms a small, strategically located portion of the bottom wall 220 of the cavity 170 where it functions as an orifice for ejection air entering the cavity 170 to force the release of food stuff. The plug 800 permits long term use of the rotary tool without the concern of fouling of the plug 800. To the extent that the combined use of the plug 800 with the air ejection technology reduces or eliminates the need for coatings and/or lubricants, the system introduces considerable economic efficiencies. The rotary tool will require less maintenance, which will result in less down time. With a reduction in down time, manufacturers can reduce their floor space as they may need fewer manufacturing lines to accomplish the same output.

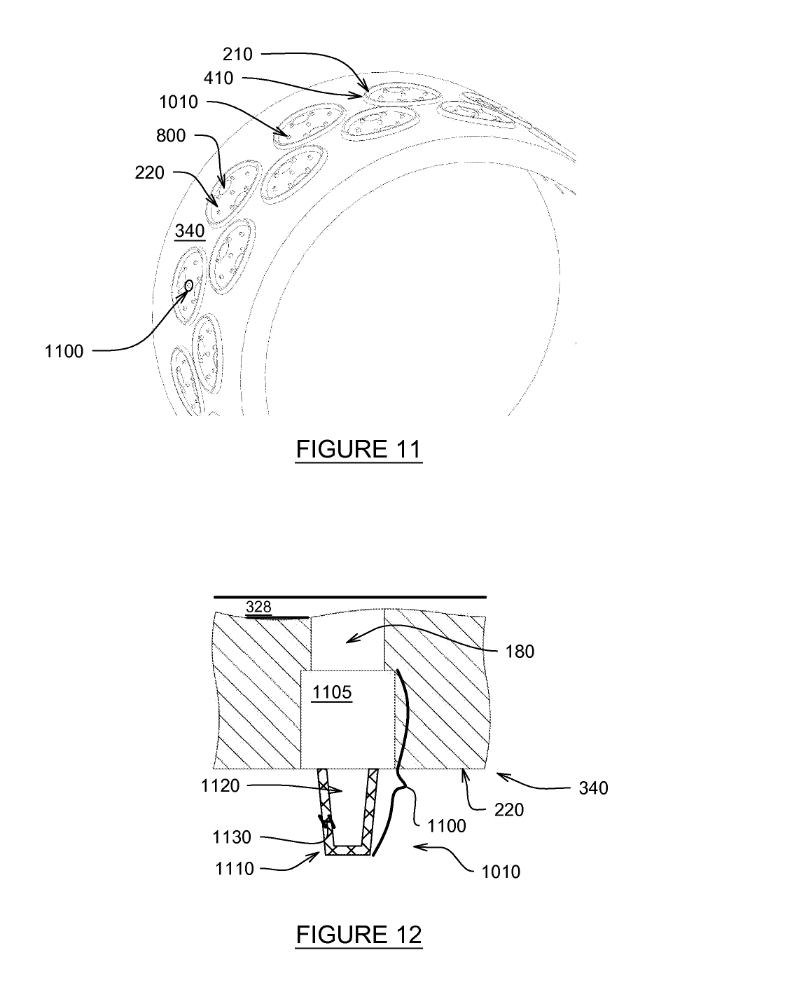

FIG. 9.A. provides a magnified assembled section view of the plug 800 assembled in the cavity 170. In FIG. 9.A., the cavity 170 may be either a mold cavity or a cutter cavity 410. An orifice 180 is also defined through the surface cylinder 305 at a region of the cavity 170. (While the orifice 180 is shown centered, it may actually be located at any position within the cavity 170, and there may be multiple orifice 180 per cavity 170 (see e.g. FIG. 11). The plug 800 is inserted into the orifice 180. Once inserts, the plug 800 may be continuous with the bottom walls 220 of the cavity 170 (including integrating and continuing any design elements thereon, or may be discontinuous with the bottom wall 220, e.g., rising above and/or sinking below the bottom wall 220).

Where the cavity 170 includes a design, the exterior surface of the plug 800 may also contain a design such that there is no interruption in the design and the plug 800 exterior surface is continuous with the bottom wall 220 of the cavity 170.

Air may flow to the orifice 180 via the channels (e.g., FIG. 8, 328). The plug 800 inserted into the orifice 180 may be constructed of the porous material that, in this example, has been processed to a shape matching the design applied to the cavity 170 by, e.g., machining processes such as cutter milling, electrostatic discharge machining (EDM), or other material shaping processes.

In a variation, the exterior face of the plug 800 may contain no design and may be located in a portion of the bottom wall 220 of the cavity 170 where design is absent. (See, e.g., FIG. 11 and description relating thereto.)

FIGS. 5, 6, and 7 illustrate a rotary cylinder 110 having thereon cutter cavities 410 instead of molder cavities 170. The difference between the molder cavities 170 and the cutter cavities 410 include that the bottom wall 220 of the cutter cavity 410 may be the surface 340 of the rotary cylinder 110 (e.g., rather than machined into the surface). An orifice 180 is drilled there through, however, the orifice 180 in the case of a cutter cavity 410, may have an originating point that begins on the surface 340 of the surface cylinder 305.

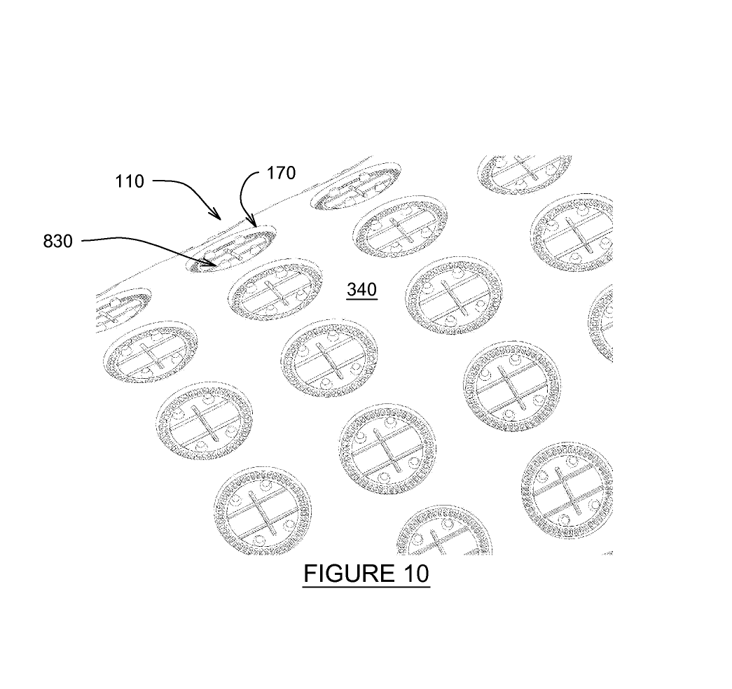

Porous material may be integrated with the rotary tool in a variety of ways and still perform the function of channeling air into the cavities 170 such that a content is ejected. FIG. 10 provides a further variation. This variation demonstrates a porous insert, which may be a machined insert 839 which is located above and substantially covers the entire bottom wall 220 of a cavity 170. For example, the machined insert 830 may extend to the full shape of the cavity 170.

The surface cylinder 305 in this example may be of a non-porous material as otherwise disclosed herein (e.g., brass, stainless steel). The arrangement of the machined insert 830 within a mold cavity 170 may permit a scraper blade to rest or contact the surface cylinder 305, leaving the machined insert 830 undisturbed.

The machined insert 830 may be fit into the mold cavity 170 such that the machined insert 830 forms the bottom wall 220 of the mold cavity 170 (or cutter cavity 410). For example, the machined insert 830, after fitting and retention, may completely cover and therefore become the bottom wall 220.

FIG. 11 provides another variation of a rotary tool. Rotary die cutting uses a cylindrical die having a rotary cylinder 110 containing a cutter cavity 410 jutting above the plane of the rotary cylinder 110. In operation, the rotary tool 100 may be assembled with a rotary press. A long sheet or web of material is fed through the rotary press into an area which holds the rotary tool, in this example, a rotary tool with cutter cavities 410. The rotary tool may cut out shapes, make perforations or creases, impart aesthetic design, and/or cut the sheet or web into smaller parts.

As a further advancement, we disclose an improved rotary cutter employing a docker pin advancement. FIG. 11 demonstrates various arrangements of docker pins on a rotary tool including cutter cavities 410. Turning to FIG. 11, a rotary cylinder 110 includes an array of cutter cavities 410 aligned on its surface face 340. The cutter cavities 410 are raised above the plane of the surface face 340. As discussed above, the cutter cavity 410 has a side wall 210 that is raised above the plane of the surface face 340. In this variation, the bottom wall 220 may be in the plane or below the plane of the face 340. The bottom wall includes an orifice FIG. 1, 180, which in this figure are shown assembled with a plug 800.

The cutter cavity 410 also includes docker pins, which may be an angled docker pin 1010. Docker pins are generally placed such that they can punch holes into the dough of a food stuff. The holes in the dough allow steam to escape during baking, thus helping to prevent the food stuff from over-inflating. Docker pins make also connect dough sheets for reduction of puffing and may aid in ejection or hold dough inside a cavity until a proper ejection position is reached. Docker pins may have a height higher than, e.g., the side wall 210 of the cavity. The cutter cavity 410 also includes a porous insert, which may be an angled docker pin plug 1100. This angled docker pin plug 1100 is demonstrated in greater detail in the FIG. 12. However, in FIG. 11, it can be seen that the angled docker pin plug 1100 inserts into an orifice 180 in the same manner as a plug 800.

With some food stuffs, for example but not limited to, cracker dough, there is a desire that the dough never touch the bottom wall 220 of the cutter cavity 410. In some situations, if the dough reaches the bottom wall 220 of the cutter cavity 410, the dough may stick and lift, which leads to tearing. FIG. 11 also illustrates how a plug 800 or docker pin plug, such as an angled docker pin plug 1100 may be placed into an orifice 180 in the bottom wall 220.

Docker pins may come in variety of formats. FIG. 11 demonstrates a docker pin of an angled variety. The angled docker pin 1100 may accommodate the draft angle of the dough sheet coming off of the rotary die. The angled variety of docker pin results in a food stuff with a rather large docker hole. Some food stuff applications desire smaller docker holes for aesthetic and functional reasons. Thin steel docker pins of a uniform diameter are capable of making smaller and more uniform docker holes. However, conventional steel docker pins catch on the dough because they are straight and cannot accommodate the draft angle.

FIG. 12, provides a detailed view of the angled docker pin plug 1100. The angled docker pin plug 1100 includes an angled spike 1110 and a base 1105. The angled spike 1110 has a diameter that increases from the outermost portion of the angled spike 1110 (e.g., furthest from the surface face 340) to where it joins the base 1105. The angled spike 1110 may have a hollow opening therein 1120. The walls of the angled spike 1110 may have a substantially constant thickness 1130. The angled spike 1110 may be constructed of porous material as disclosed herein. The base 1105 of the docker pin plug 1100 may also be constructed of porous material. The base 1105 of the docker pin plug 1100 may be unified with the angled spike 1110, or may be a multi-piece construction. The hollow opening 1120 may reduce the air resistance of the spike over the resistance the air would encounter if the spike was made of a solid porous material. Airflow traveling from the channel 328 and through the angled docker pin plug 1100 may assist the ejection efficiency of the food stuff contacted by the cavity 170. Ejection air may exit the angled docker pin plug 1100 where the base 1105 forms a continuous face at the surface face 340 and through the exterior diameter of the angled spike 1110 of the docker pin plug 1100.

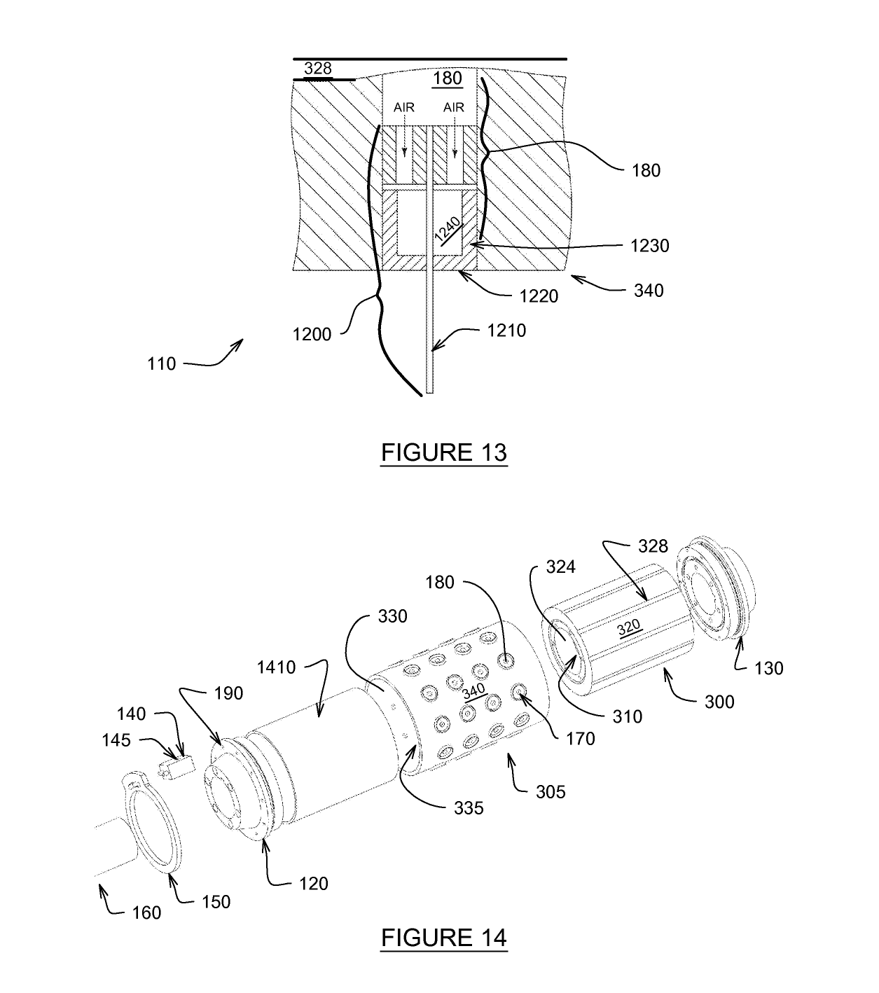

Turning to FIG. 13, a rotary cylinder 110 includes an orifice 180. The orifice 180 is in fluid communication with a channel 328. The orifice 180 may be assembled with a porous insert, which may be a barb docker pin plug 1200. In a variation, the barb docker pin plug 1200 may include a base 1220 and a barb 1210. The barb docker pin plug 1200 may be dimensioned to assemble with the orifice 180. The base 1220 of the barb docker pin plug 1200 may be constructed of porous material. In one variation, the base 1220 may include walls 1230 defining an opening 1240. In another variation, the base 1220 may be solid. The barb 1210 may be made of, for example but not limited to, steel, brass, ceramic, composites, and other materials. Airflow traveling from the channel 328 and through the barb docker pin plug 1200 may assist the ejection efficiency of the food stuff contacted by the cavity 170. For example, the airflow may overcome the tendency for food stuff to hang up on the barb 1210. Ejection air may exit the barb docker pin plug 1210 where the base 1105 or 1220 forms a continuous and/or discontinuous face at the surface face 340 and prohibit food stuff from sticking to the barb 1210 and or to the surface face 340 located as the bottom wall 220 of the cavity 410.

The porous material may be sized by, for example but not limited to, electric discharge machining, to a precision size and shape for fit and retention in the orifice 180. Docker pins of many sizes and lengths are used in rotary tool design. Size is determined by the specific needs, both technical and aesthetic.

It should be understood that in all variations, the porous material may be a micro-drilled material. In one example, the plug 800, which may be replaced by any plug disclosed herein (e.g., angled docker pin plug 1100, barb docker pin plug 1200, etc.). The plug may be precision machine shaped material. The plug may be dimensioned to fit into the orifice 180 such that the exterior portion of the plug 800 is continuous with, in the case of a cutter design, the surface face 340 of the rotary cylinder 110, and in the case of the mold design, the bottom wall 220 of the cavity 170 (which in the mold format may be below of the surface face 340). In either case, the exterior portion of the plug may be continuous with the bottom wall 220 of the cavity 170, the only difference being whether the cavity is continuous with the surface face 340 or below the surface face 340.

As discussed herein, if the cavity 170 includes a design the plug 800 may be placed in a portion of the cavity 170 that has no design. Alternatively or additionally, if the cavity 170 includes a design the exterior face of the plug 800 may also have a design that is continuous with the design of the cavity 170, such that there is no interruption in the pattern. Alternatively or additionally, the cavity 170 may include no design, and the exterior surface of the plug 800 may have a design, such that, when integrated with the cavity 170 and contacted with food stuff, the plug 800 imparts a design to the food stuff.

Rotary tools may be mounted in any commercial rotary machine, including single roll and dual roll machines. The rotary cutter may use either molds or cutters. The molds and cutters may be continuous with the surface face 340. The molds may be above the plane of the surface face 340 of the rotary cylinder 110 or below the plane of the surface face 340 of the rotary cylinder 110. Similarly, the cutters may have portions that rise above the surface face 340 of the rotary cylinder 110. The cutters may also have portions (e.g., the bottom wall 220) that are below the plane of the surface face 340 of the rotary cylinder 110. The location of an orifice 180 is not limited to a center location within the cavity 170. There may be more that one orifice 180 in a cavity 170. The cavity 170 may have various shapes and sizes.

The ejection technology may substantially improve tool performance and thereby increase efficiency and decrease cost, e.g., by reducing down time and maintenance. The ejection technology may further permit formulation changes such as reduced fat, without losing ejection integrity. Product quality also improves as the ejection technology may decrease product distortion, leading to product consistency (visual and otherwise). The ejection technology may also increase the range of possible shapes and sizes of product without impact on tool performance.

While an air block 140 is shown as a one port air block, the air block 140 may be a larger block with the capability of injecting air into all of the channels 328 at once (versus the timed pulse). When cleaning the rotary tool, air may be simultaneously injected into all channels 328 (and thus all orifices 180) such that the cleaning fluids applied to the exterior portion of the rotary tool are prohibited from entering the air manifold, e.g., via the orifices 180 or otherwise.

FIG. 14 provides an assembly view of a variation of a rotary tool. In a variation, a rotary cylinder 110 may include a surface cylinder 305, a first hub 120, a second hub 130, a manifold cylinder 300, a shaft 160, an adjustment plate 150, and an air block 140. The rotary tool of this variation may also include a porous cylinder 1410. The porous cylinder 1410 may be a hollow cylinder, defining an opening. The opening may be dimensioned to receive a manifold cylinder 300. The manifold 300 may include channels. In a variation, the manifold cylinder 300 may have an outer manifold surface 320 and an inner manifold surface 324. The outer manifold surface 320 may include channels 328 machined therein (e.g., on the surface) or drilled there through (e.g., beneath the surface). The channels 328 may be arranged longitudinally on the outer manifold surface 320. The channels 328 may be applied to the surface of the manifold cylinder 300 in any effective manner, e.g. etching, milling, EDM (electrical discharge machining), molding, or engraving processes. The number and spacing of the channels 328 may vary depending on the desired application.

The surface cylinder 305 may be a hollow cylinder, defining an assembly opening 335 there through. The surface cylinder 305 may have an inner face 330 and a surface face 340. In a rotary mold variation, the surface cylinder 305 may have a plurality of cavities 170 defined therein. The cavities 170 may be arranged in longitudinal rows of one or more cavities 170 on the surface cylinder 305. The cavities 170 may include an orifice 180 passing there through.

The surface cylinder 305 may be assembled with the porous cylinder 1410, for example, by inserting the porous cylinder 1410 into the assembly opening 335 of the surface cylinder 305. The porous cylinder 1410 may be assembled with the manifold cylinder 300, for example, by inserting the manifold cylinder 300 into the opening of the porous cylinder 1410. The channels 328 on the outer manifold surface 320 may align with the orifice 180 located in the cavities 170. Alignment of the channels 328 on the outer manifold surface 320 with the orifice 180 located in the cavities 170 may permit fluid communication between the channels 328 and the orifice 180.

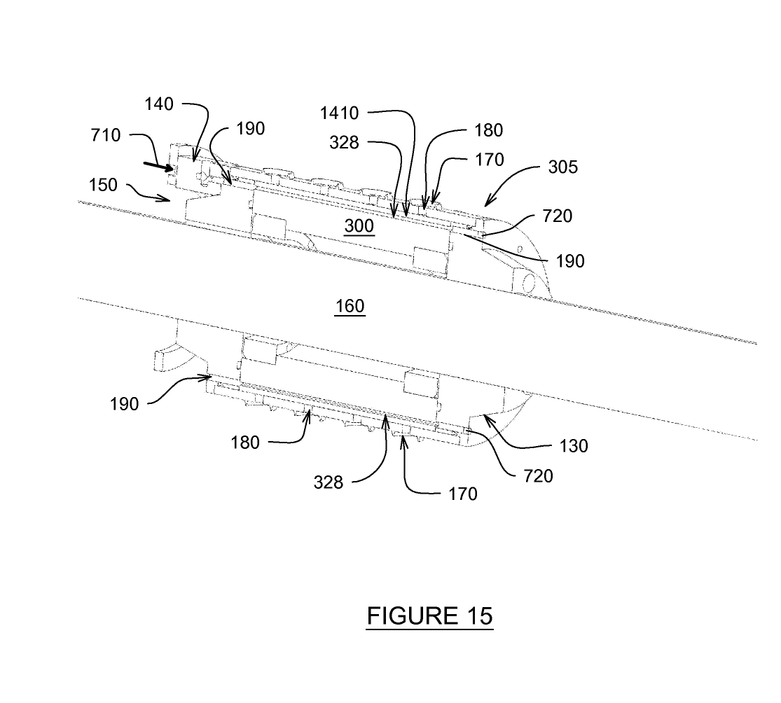

FIG. 15 provides a cross section view of a rotary tool incorporating a porous cylinder 1410. This view provides further illustration of air flow. The section is cut through a centerline of a port 190 in the first hub 120 in alignment with a channel 328 and also in cross section alignment with orifices 180 through the cavities 170. In this view the porous cylinder 1410 is clearly shown between the surface cylinder 305 and the manifold 300. Direction of air flow is indicated by the arrow 710. Air enters the air block 140 and, when the air block 140 is aligned with a port 190, air travels through the port 190 into the channel 328 and is ejected through the orifices 180. The air supplied to the orifices 180 provide an ejection force to any materials in the cavities 170.

While variations of the invention have been described, it will be apparent to those of skill in the art that many more implementations are possible that are within the scope of the claims.

1. A rotary tool comprising:
a rotary cylinder;
the rotary cylinder having a surface;
a plurality of cavities on the surface of the rotary cylinder;
the cavities comprising a porous insert; and
a channel disposed beneath and in fluid communication with the cavities.

2. The rotary tool of claim 1, further comprising:
the cavities are mold cavities.

3. The rotary tool of claim 1, further comprising:
the cavities are cutter cavities.

4. The rotary tool of claim 1, further comprising:
the cavities having side walls and a bottom wall, the side walls continuous with the bottom wall,
the bottom wall having an orifice in fluid communication with the channel; and
the porous insert located within the orifice.

5. The rotary tool of claim 4, further comprising:
the porous insert is a docker pin plug.

6. The rotary tool of 1, further comprising:
the cavities having side walls and a bottom wall, the side walls continuous with the bottom; the side walls and the bottom wall having a product shape;
the bottom wall having an orifice in fluid communication with the channel; and
the porous insert is a machined insert located above the bottom wall and the porous insert comprising the product shape.

7. The rotary tool of claim 1, the rotary cylinder further comprising:
a surface cylinder;
the surface cylinder defining an assembly opening there through;
a manifold cylinder; and
the manifold cylinder assembled in the assembly opening of the surface cylinder.

8. The rotary tool of claim 7, the manifold cylinder having an exterior surface; the exterior surface of the manifold cylinder comprising channels; the cavities aligned on the surface cylinder; the cavities having side walls and a bottom wall, the side walls continuous with the bottom wall, the bottom wall having an orifice passing through the surface cylinder; and the manifold cylinder assembled in the assembly opening of the surface cylinder, such that the channels of the manifold cylinder are in fluid communication with the orifice of the surface cylinder.

9. The rotary tool of claim 7, the rotary cylinder further comprising: a porous cylinder located between the surface cylinder and the manifold cylinder.

10. The rotary tool of claim 1, further comprising:
at least one hub;
the at least one hub abutting the rotary cylinder;
the at least one hub comprising radially spaced ports; and
the radially spaced ports in fluid communication with the channel.

11. The rotary tool of claim 10, further comprising:
at least one air block;
the air block assembled with the at least one hub; and
the air block aligned for fluid communication with the radially spaced ports.

12. A rotary tool comprising:
a rotary cylinder;
the rotary cylinder comprising a surface cylinder and a manifold cylinder;
the surface cylinder having a surface face, the surface face comprising a plurality of cavities;
the surface cylinder defining an assembly opening there through;
a manifold cylinder;
the manifold cylinder comprising a channel; and
the manifold cylinder assembled in the assembly opening of the surface cylinder such that the channels of the manifold cylinder are in fluid communication with the cavities of the surface cylinder.

13. The rotary tool of claim 12, the surface cylinder comprising a porous material.

14. The rotary tool of claim 12, further comprising:
at least one hub;
the at least one hub abutting the rotary cylinder;
the at least one hub comprising radially spaced ports; and
the radially spaced ports in fluid communication with the channel.

15. The rotary tool of claim 14, further comprising:
at least one air block;
the air block assembled with the at least one hub; and
the air block aligned for fluid communication with the radially spaced ports.

16. The rotary tool of claim 15, the cavity comprises a mold cavity.

17. The rotary tool of claim 12, the cavity comprises a cutter cavity.

18. The rotary tool of claim 12, further comprising:
the cavities having side walls and a bottom wall, the side walls continuous with the bottom wall,
the bottom wall having an orifice in fluid communication with the channel; and
a porous insert located within the orifice.

19. The rotary tool of claim 12, further comprising:
the porous insert is a docker pin plug.

20. The rotary tool of claim 18, further comprising:
the cavities having side walls and a bottom wall, the side walls continuous with the bottom; the side walls and the bottom wall having a product shape;
the bottom wall having an orifice in fluid communication with the channel; and
the porous insert is a machined insert located above the bottom wall and the porous insert comprising the product shape.
